(19) United States
(12) Patent Application Publication
(10) Pub. No.: US 2004/0025142 A1
(43) Pub. Date: Feb. 5, 2004

(54) Method and apparatus for managing objects in a CIM environment

(75) Inventors: Chhandomay Mandal, Nashua, NH (US); Juan C. Zuluaga, Medford, MA (US)

Correspondence Address: KUDIRKA & JOBSE, LLP, ONE STATE STREET, SUITE 800, BOSTON, MA, 02109, US

(73) Assignee: Sun Microsystems, Inc., Santa Clara, CA

(21) Appl. No.: 10/212,601

(22) Filed: Aug. 5, 2002

(51) Int. Cl. G06F 9/44

(52) U.S. Cl. 717/104; 717/120

(57) ABSTRACT

Information concerning CIM classes and instances used to model a managed system is stored in two hash tables that are built at runtime when instances are added to the system. The first hash table, called a subclass table, identifies the subclasses of each CIM class. The second hash table, called an instance table, identifies the instances in the system for each class. The instance and subclass tables are used to retrieve information concerning the CIM instances. In particular, the instance table is used to retrieve all instances of a particular class and the subclass table is used to determine which classes to examine for instances. In one embodiment, the instance table is a hash table that contains a plurality of hash tables. The first hash table, called the primary instance table, contains key-value pair entries, in each entry the key is a CIM class and the value is a secondary hash table that contains the instances of that CIM class. The secondary hash table also contains key-value pair entries. For each entry, the key is the OID value of one instance of the CIM class used as the key in the instance table and the value is the instance.

### FIELD OF THE INVENTION

This invention relates to object management in a Common Information Model system and, specifically, to methods for modeling complex systems using a Managed Object Format.

### BACKGROUND OF THE INVENTION

The Common Information Model, or CIM, is an object-oriented information model for describing managed resources such as disks, CPUs, and operating systems. This model is a proposed industry standard that is promulgated by the Distributed Management Task Force, Inc. and is described in detail in the Common Information Model Specification, version 2.2, Jun. 14, 1999. This document is available at http://www.dmtf.org and is incorporated by reference in its entirety.

CIM provides an implementation independent common conceptual framework to not only classify and define the parts of a networked environment, but also to depict how these parts operate together. Different vendors can supply hardware and software elements that are CIM-compliant, and another third party provider can independently design, implement and sell management software for CIM-compliant systems.

A CIM description is comprised of a Specification and a Schema. The Specification defines the details for integration with other management models, while the Schema provides the actual model descriptions.

In the CIM model, managed resources, such as printers, disk drives, or CPUs are represented by CIM objects. CIM objects can be shared by any WBEM-enabled system, device, or application. CIM objects with similar properties and purposes are represented as CIM classes. Properties are attributes that describe a unit of data for a class. An instance is a representation of a managed object that belongs to a particular class. Instances contain actual data. For example, Solaris_ComputerSystem is a CIM class that represents a computer that runs the Solaris™ operating environment. Solaris is a trademark of Sun Microsystems, Inc. The Solaris software that runs on a SUN workstation is an instance of the Solaris_OperatingSystem class. ResetCapability and InstallDate are examples of properties of the Solaris_ComputerSystem class. CIM providers are classes that communicate with managed objects to access data.

Each schema comprises a meaningful collection of CIM classes with a single owner (an organization). Schemas are used for administration and class naming and each CIM class can belong to only one schema. All class names must be unique within a particular schema. The schema name is the determining factor in differentiating classes and properties from others that may have the same name.

The Common Information Model categorizes information from general to specific and each CIM schema is divided into three layers of information. These include a core layer that comprises a subset of CIM not specific to any platform and a common layer that comprises information which visually depicts concepts, functionality, and representations of entities related to specific areas of network management, such as systems, devices, and applications. The third layer is an extension layer that comprises information models that support the CIM Schema and represent a very specific platform, protocol, or corporate brand.

CIM uses a standard language called Managed Object Format (MOF) to define CIM elements. The MOF language is similar to traditional object-oriented programming languages in that CIM elements are represented by instances of classes. The MOF language specification also specifies a syntax for defining CIM classes and instances that is similar to the syntax used in other object-oriented programming languages. However, modeling in CIM, and, in particular, modeling of associations between objects in CIM is different from traditional object-oriented modeling in the sense that associations between objects are treated as distinct classes in CIM. The difference is illustrated in FIGS. 1A and 1B.

FIG. 1A shows two classes, class A 100 and class B 102. An association between the classes is represented by an arrow 104 and conveys the information that Class A has an aggregation of Class B objects. In a traditional object-oriented language like Java, code corresponding to FIG. 1A will look something like the following code snippet.

```
public class ClassB {
...
}
public class ClassA {
    private ClassB[] classBInstances = null;
    ...
    public void setClassBInstances( ClassB[] classBInstances ) {
        this.classBInstances = classBInstances;
    }
    public ClassB[] getClassBInstances( ) {
        return classBInstances;
    }
    ...
}
```

From the code snippet above, it is clear that, given an instance of the Class A, the instances of Class B that are associated with the instance of Class A can be directly retrieved. However, in order to associate the two classes in a CIM environment, another class, for example Class C, would have to be introduced to represent the association between Class A and Class B as shown in FIG. 1B. FIG. 1B shows two classes, Class A 106 and Class B 108 associated by a third Class C 110. The MOF file corresponding to this figure will look like the following code snippet.

[ Description ( “Some Class A” ) ]
class ClassA {
OID oid;
...
};
[ Description( “Some Class B” ) ]
class ClassB {
OID oid;
...
};
[ Association, Description( “Some Association Class C” ) ]
class ClassC {
OID oid;
ClassA REF antecedent;
ClassB REF dependent;
};

In the above code snippet, the term “OID” refers to an object identifier class, and each instance of any class in CIM has an identifier that uniquely identifies the instance. Therefore, in order to enumerate all Class B instances that are associated with the given instance of Class A, all instances of Class C must be examined to find all the instances whose antecedent refers to the given instance of Class A. The collection of the dependent references for the matching Class C instances produces the desired enumeration of Class B objects associated with the instance of Class A.

The CIM model generates more classes (and their instances) than a traditional object-oriented model. Any CIM model corresponding to a real system is itself complicated. In addition, there will be one extra class per association between objects. Thus, management software for CIM-compliant systems must keep track of potentially thousands of objects, all of which should be identifiable with a given OID. Moreover, the management system should be able to retrieve an instance given an OID in a reasonably short time (that is it should have good performance in query support, model traversal etc.). In order to achieve good performance, the conventional method of tracking CIM instances and associations involves storing references to the CIM instances and associations in a hash table that is keyed by the OID as described below. Then the hash table can be queried by the key to retrieve the desired components.

The conventional hash table approach is illustrated in connection with a very simplified model of a computer system that is shown in FIG. 2. In this model, a generic computer system is represented by a Host object class 206. The WindowsHost object class 212 and the SolarisHost object class 214 are specialized subclasses of the Host object class 206. The NTHost object class 220 is a further subclass of the WindowsHost object class 212.

There are three association classes, the SCSIINterface class 222, the SystemDevice class 224 and the SystemSoftware class 226. In the rest of this description, the term “domain object” is used to refer the object classes (Host object class 206, WindowsHost object class 212, SolarisHost object class 214, NTHost object class 220, OS object class 202, Port object class 210 and StorageVolume object class 218), and the term “association object” is used to refer to the association classes (SystemSoftware association class 226, SystemDevice association class 224 and SCSIInterface association class 222).

In the system shown in FIG. 2, the OS object class 202 is associated to the Host object class 206 via an instance 204 of the SystemSoftware association class. Similarly, the Port object class 210 is associated with the Host object class 206 via an instance 208 of the SystemDevice association class. A StorageVolume object class 218 is associated with the Port object class 210 via an instance 216 of the SCSIInterface association class. The corresponding MOF file for the model in FIG. 2 is shown below.

```
// =================================================================
// Generic Pragmas
// =================================================================
#pragma locale (“en_US”)
// =================================================================
// Host
// =================================================================
  [Description (
    “A class called Host ”)
  ]
  class Host
  {
      OID oid;
      string Name;
  };
// =================================================================
// WindowsHost
// =================================================================
  [Description (
    “A class called WindowsHost ”)
  ]
  class WindowsHost : Host
  {
  };
// =================================================================
// SolarisHost
// =================================================================
  [Description (
    “A class called SolarisHost ”)
  ]
  class SolarisHost : Host
  {
  };
// =================================================================
// NTHost
// =================================================================
  [Description (
    “A class called NTHost ”)
  ]
  class NTHost : WindowsHost
  {
  };
// =================================================================
// OS
// =================================================================
  [Description (
    “A class called OS ”)
  ]
  class OS
  {
    OID oid;
    string version;
  };
// =================================================================
// Port
// =================================================================
  [Description (
    “A class called Port ”)
  ]
  class Port
  {
      OID oid;
      String Name;
      string PermanentAddress;
      uint64 MaxSpeed;
  };
// =================================================================
// StorageVolume
// =================================================================
  [Description (
    “A class called StorageVolume ”)
  ]
  class StorageVolume
  {
    OID oid;
    string Volume;
  };
// =================================================================
// SystemSoftware
// =================================================================
  [Association,
  Description (
    “An association class called SystemSoftware ”)
  ]
  class SystemSoftware
  {
      Host REF antecedent;
      OS REF dependent;
  };
// =================================================================
// SystemDevice
// =================================================================
  [Association,
  Description (
    “An association class called SystemDevice ”)
  ]
  class SystemDevice
  {
      Host REF groupComponent;
      Port REF partComponent;
  };
// =================================================================
// SCSIInterface
// =================================================================
  [Association,
  Description (
    “An association class called SCSIInterface ”)
  ]
  class SCSIInterface
  {
      Port REF antecedent;
      StorageVolume REF dependent;
  };
```

For purposes of illustration, consider a scenario where management software is managing an environment that has three hosts. One of these hosts is running the Solaris 8 operating system, another is running the Windows NT operating system and the third is running the Linux operating system. The complete set of CIM instances for this scenario (using the CIM model shown in FIG. 2) is shown in FIGS. 3A-3C. In these figures, the unique identifier of each instance (that is, the OID) is included in double quotes(“”), and the name of the CIM class is illustrated within parentheses. In this scenario, the “Host A” class 302 shown in FIG. 3A is an instance of the SolarisHost class 214. Class 302 is associated with an “OS 1” operating system class 300 by the “SS 1” association class illustrated as a line connecting classes 300 and 302. Class 302 is also associated with Port class “Port A1” 304 by the “SD 1” association class shown as a line connecting the classes. Similarly, the storage volume class “SV A1” 306 is associated with the Port class 304 by the “SI 1” association class.

As shown in FIG. 3B, “Host B” class 310 is an instance of NTHost class 220. Class 310 is associated with an “OS 2” operating system class 308 by the “SS 2” association class illustrated as a line connecting classes 308 and 310. Class 310 is also associated with Port class “Port B1” 312 by the “SD 21” association class shown as a line connecting the classes. Similarly, the storage volume class “SV B1” 316 is associated with the Port class 312 by the “SI 21” association class. Class 310 is further associated with Port class “Port B2” 314 by the “SD 22” association class shown as a line connecting the classes. Similarly, the storage volume class “SV B2” 318 is associated with the Port class 316 by the “SI 22” association class.

As shown in FIG. 3C the “Host C” class 322 is an instance of Host class 206 (as there is no LinuxHost class). Class 322 is associated with an “OS 3” operating system class 320 by the “SS 3” association class illustrated as a line connecting classes 320 and 322. Class 322 is also associated with Port class “Port C1” 324 by the “SD 3” association class shown as a line connecting the classes. Similarly, the storage volume class “SV C1” 326 is associated with the Port class 324 by the “SI 3” association class.

The management software should be able to successfully run queries like “get the instance with OID xxx,” “get all hosts,” “get all windows host,” “get all the volumes in host with OID xxx” etc. with good performance. All of the instances are uniquely identifiable by their OID value. Therefore, in a conventional system, the instances are stored in a hash table with the OID of each instance as the key for that instance. This straightforward approach will lead to a hash table similar to shown in Table 1.

TABLE 1

| KEY | VALUE |
|---|---|
| “Host A” | Corresponding SolarisHost Domain Object Instance |
| “Host B” | Corresponding NTHost Domain Object Instance |
| “Host C” | Corresponding Host Domain Object Instance |
| “OS 1” | Corresponding OS Domain Object Instance |
| “OS 2” | Corresponding OS Domain Object Instance |
| “OS 3” | Corresponding OS Domain Object Instance |
| “Port A1” | Corresponding Port Domain Object Instance |
| “Port B1” | Corresponding Port Domain Object Instance |
| “Port B2” | Corresponding Port Domain Object Instance |
| “Port C1” | Corresponding Port Domain Object Instance |
| “SV A1” | Corresponding StorageVolume Domain Object Instance |
| “SV B1” | Corresponding StorageVolume Domain Object Instance |
| “SV B2” | Corresponding StorageVolume Domain Object Instance |
| “SV C1” | Corresponding StorageVolume Domain Object Instance |
| “SS 1” | Corresponding SystemSoftware Association Object Instance |
| “SS 2” | Corresponding SystemSoftware Association Object Instance |
| “SS 3” | Corresponding SystemSoftware Association Object Instance |
| “SD 1” | Corresponding SystemDevice Association Object Instance |
| “SD 21” | Corresponding SystemDevice Association Object Instance |
| “SD 22” | Corresponding SystemDevice Association Object Instance |
| “SD 3” | Corresponding SystemDevice Association Object Instance |
| “SI 1” | Corresponding SCSIInterface Association Object Instance |
| “SI 21” | Corresponding SCSIInterface Association Object Instance |
| “SI 22” | Corresponding SCSIInterface Association Object Instance |
| “SI 3” | Corresponding SCSIInterface Association Object Instance |

Given the OID of an instance, it can be retrieved easily from the hash table as it is keyed by the OID itself. However, an average successful search in a hash table that uses chaining for collision resolution takes time O(1+n/m), where n is the number of entries in the table (i.e. total number of instances in the system) and m is the number of rows in the table. For a fixed m, as n increases (a usual scenario in real systems) the time needed for a successful search becomes O(n). This time is lengthy and reduces system performance.

Further, to support queries like “get all hosts,” information identifying classes that are subclasses of a given class must be “hard-coded” into the management software. For example, in order to perform a “get all hosts” query, information identifying all instances that are instantiated from subclasses of the Host, WindowsHost, SolarisHost and NTHost classes must be enumerated at compilation time, since this information can not be determined at the run time.

### SUMMARY OF THE INVENTION

In accordance with the principles of the invention, information concerning the CIM classes and instances is stored in two hash tables. The first hash table, called a subclass table, identifies the subclasses of each CIM class. The second hash table, called an instance table, identifies the instances in the system for each class. In accordance with one embodiment, the instance and subclass tables are used to retrieve information concerning the CIM instances. In particular, the instance table is used to retrieve all instances of a particular class and the subclass table is used to determine which classes to examine for instances.

In another embodiment, the instance table is a hash table that contains a plurality of hash tables. The first hash table, called the primary instance table, contains key-value pair entries, in each entry the key is a CIM class and the value is a secondary hash table that contains the instances of that CIM class. The secondary hash table also contains key-value pair entries. For each entry, the key is the OID value of one instance of the CIM class used as the key in the instance table and the value is the instance.

In accordance with still another embodiment, the two hash tables are built at runtime. In particular, entries are made in the two tables at runtime only when an instance of a subclass is added to the object collection maintained by the CIM object manager.

### BRIEF DESCRIPTION OF THE DRAWINGS

The above and further advantages of the invention may be better understood by referring to the following description in conjunction with the accompanying drawings in which:

FIG. 1 is a prior art class diagram illustrating a class and subclass relationship.

FIG. 2 is a simplified prior art class diagram of CIM classes used to model an illustrative schematic computer.

FIGS. 3A-3C are prior art diagrams of CIM domain and association object instances for an illustrative computer system configuration.

FIGS. 4A and 4B are schematic illustrations of subclass and instance tables constructed in accordance with the principles of the present invention.

FIGS. 5A-5C, when placed together, form a flowchart that shows the steps in an illustrative process for creating subclass and instance table entries when an object instance is added to the system.

FIGS. 6A and 6B, when placed together, form a flowchart that shows the steps in an illustrative process performed by an object manager in responding to a “getAllHosts” query on the system illustrated in FIGS. 3A-3C.

FIG. 7 is a flowchart that shows the steps in an illustrative process performed by an object manager in responding to a “get a Host instance with the OID Host A” query on the system.

FIGS. 8A and 8B, when placed together, form a flowchart that shows the steps in an illustrative process performed by an object manager in responding to a “get Host with OID Host D” query in the system.

FIGS. 9A-9C, when placed together, form a flowchart that shows the steps in an illustrative process performed by an object manager in responding to a “get all the Storage Volumes of Host with OID Host B” query in the system.

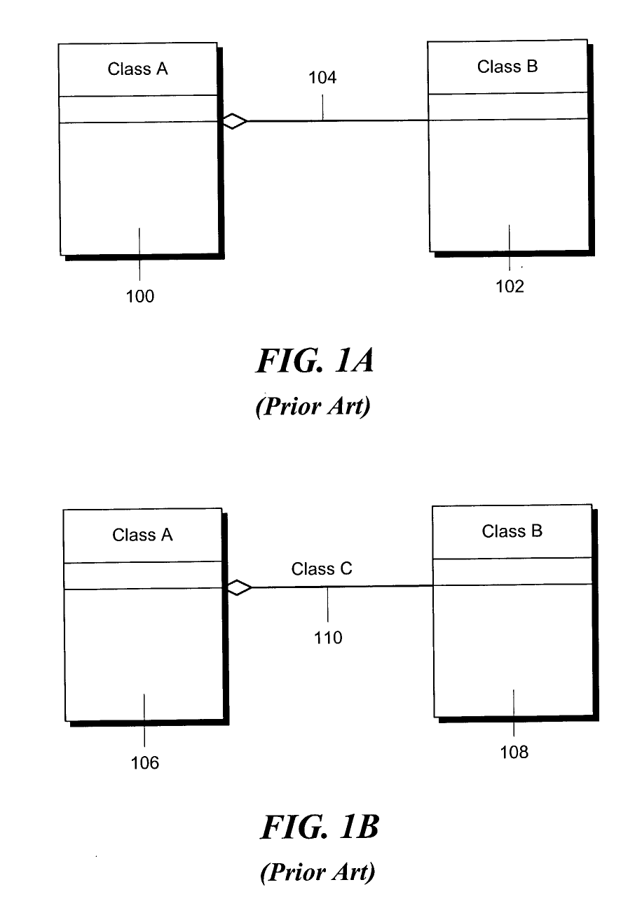

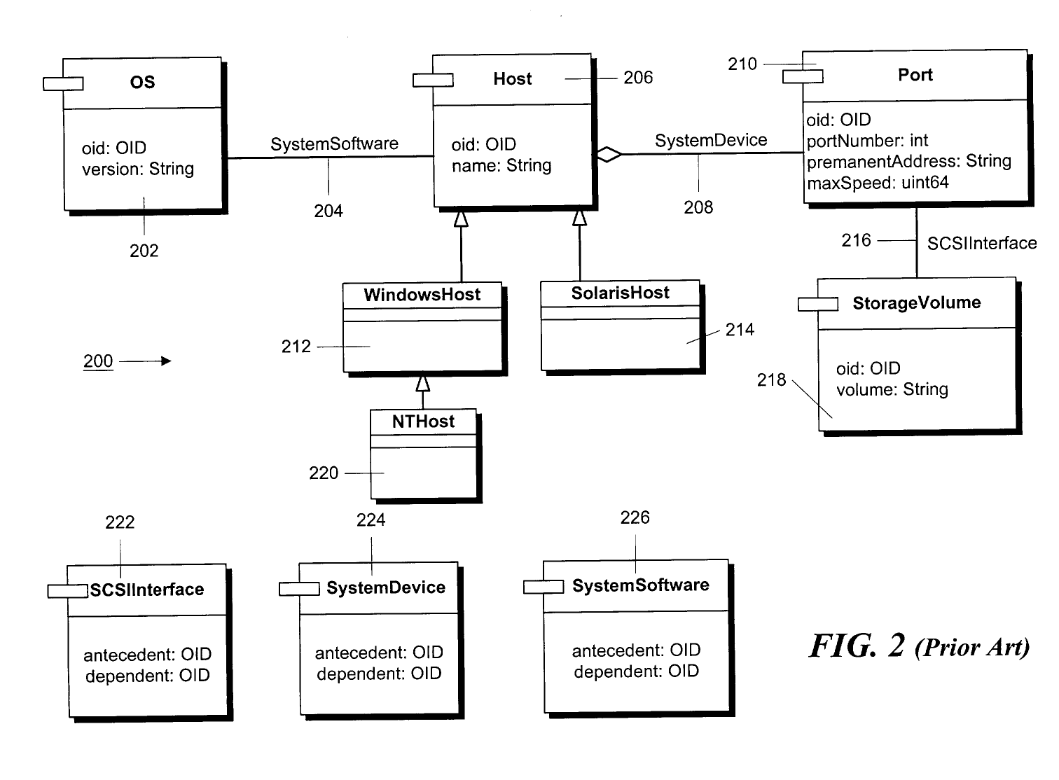

### DETAILED DESCRIPTION

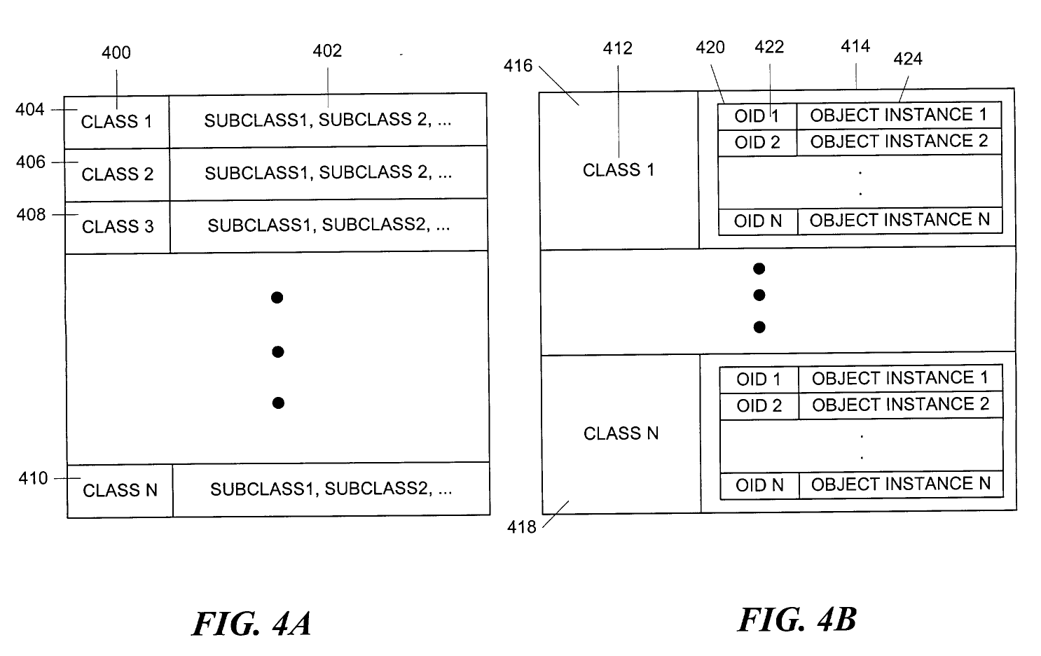

In accordance with the principles of the invention, the first, or subclass, hash table contains information identifying the subclasses of a given class. An illustrative example of this table is shown in FIG. 4A. This hash table contains key-value pair entries, of which entries 404-410 are shown. The subclass table may illustratively be a conventional hash table generated by software subroutines. Such a table could use chaining for collision resolution in a conventional manner. Other conventional collision resolution mechanisms could also be used. In order to simplify the following discussion, a description of these collision resolution mechanisms has been omitted.

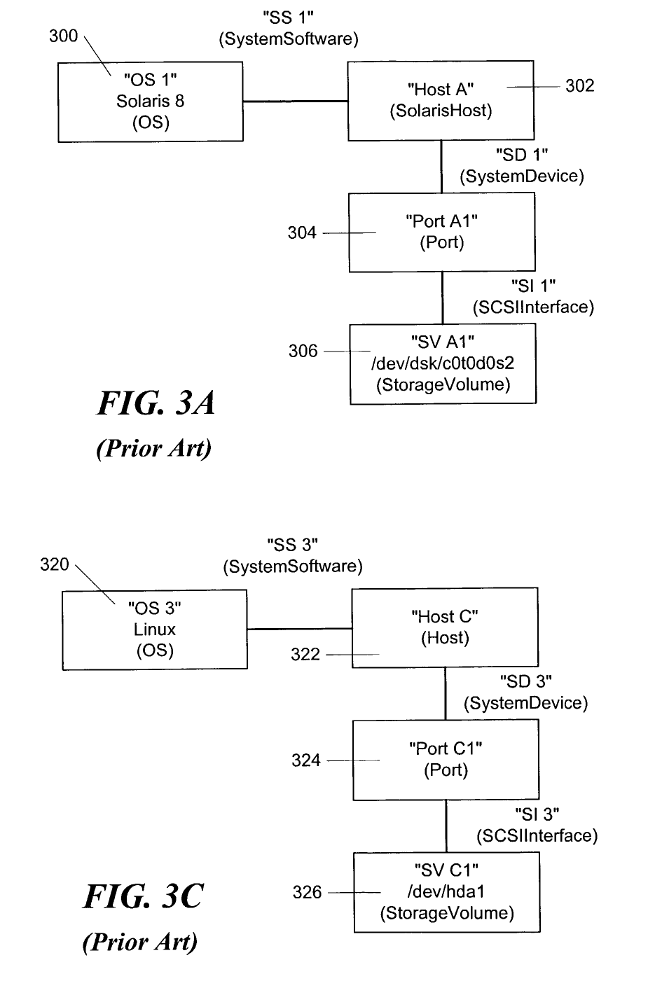

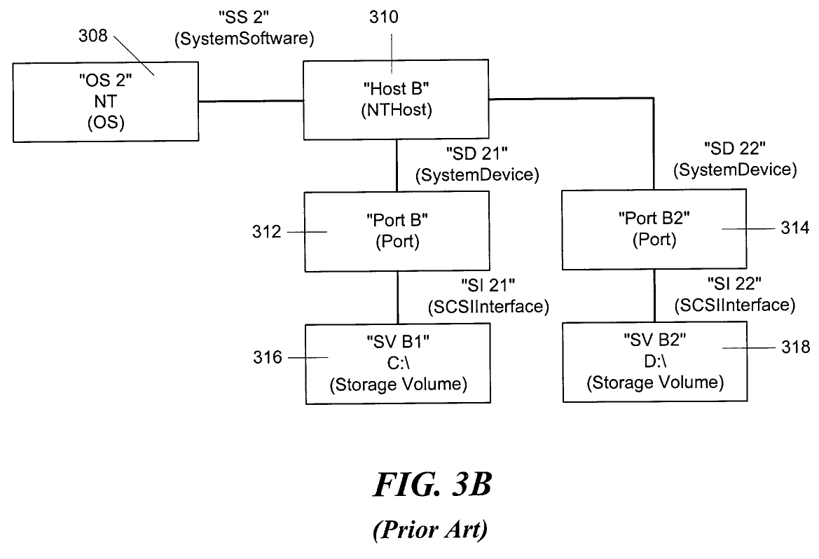

Each key-value pair, for example pair 404, has as the key 400, the parent class and as the value 402, one or more subclasses of the parent class identified by the key. The value portion 402 of the table can be implemented as a linked list or an array. An entry is inserted into the subclass table only when an instance of a subclass is added in the collection maintained by the object manager. For example, using the illustrative system shown in FIGS. 3A-3C and assume that first a “Host A” instance 302 (a SolarisHost instance) is added, and then a “Host B” 310 instance (a NTHost instance) is added to the repository maintained by the object manager. Before either of these instances is added, the subclass table would not contain any key-value pair. After “Host A” is added, the subclass table would look like Table 2.

TABLE 2

| Key (Parent Class) | Value (Children classes) |
|---|---|
| Host | SolarisHost |

At this point, if a query is made to retrieve Host related information, the object manager will access the subclass table via the key (Host) and, retrieving the value of the key value pair, discover that it must examine related information for instances of both the Host and SolarisHost classes because the subclass table indicates that SolarisHost is a subclass of Host. Then the object manager would use the SolarisHost value as a key and re-access the table to determine if any subclasses of SolarisHost exist. In this example, no subclasses of SolarisHost are indicated in the table.

After “Host B” is added, the subclass table would look like Table 3.

TABLE 3

| Key (Parent Class) | Value (Children classes) |
|---|---|
| Host | SolarisHost, WindowsHost |
| WindowsHost | NTHost |

Since the WindowsHost class is a subclass of the class Host, it is added to the list value associated with the Host key. In addition, since the WindowsHost class also has its own subclass, NTHost, an additional entry is added to the table to reflect this relationship. Now, in accordance with the updated table, the object manager will access the table using the “Host” key and find the SolarisHost and WindowsHost subclasses in the corresponding value. The object manager will then re-access the table using the SolarisHost class and the WindowsHost class as keys. When the WindowsHost class is used as a key, the object manager will discover the NTHost subclass in the corresponding value. This latter subclass will also then be used to reaccess the table to determine if any further subclasses exist. Thus, the object manager will examine all instances of the Host, SolarisHost, WindowsHost and NTHost classes to answer queries pertaining to Host. When “Host C” 322 is added, Table 3 will not change as “Host C” is just an instance of the Host class. In fact, any subsequent addition of any host of any type would not change the contents of Table 3 as complete hierarchy-related information is already stored in the table. Note that this table is built at run time when instances are added, so no information must be “hard coded” at compile time.

As discussed, the second, or instance, hash table comprises a primary hash table that contains a plurality of secondary hash tables. An illustrative example of this table is shown in FIG. 4B. In particular, the primary hash table contains key-value pairs, of which pairs 416 and 418 are shown. Each key 412 in the primary instance hash table is a CIM class, in particular, one of the classes or subclasses in the subclass table. In general, each class and subclass in the subclass table would have an entry in the instance table. The value 414 of the key-value pair in the primary hash table is a secondary hash table 420 that contains references to all instances of the CIM class used as the key. The secondary hash table also contains key-value pairs. In each key-value pair, the key 422 is an OID of one instance of the CIM class and the value 424 is a reference to the instance.

An exemplary instance table for the CIM class instances shown in FIGS. 3A-3C is shown in Table 4.

TABLE 4

| KEY | VALUE |
|---|---|
| SolarisHost | Key |
| | Value |
| | “Host A” |
| | Corresponding SolarisHost Domain Object Instance |
| NTHost | Key |
| | Value |
| | “Host B” |
| | Corresponding NTHost Domain Object Instance |
| Host | Key |
| | Value |
| | “Host C” |
| | Corresponding Host Domain Object Instance |
| OS | Key |
| | Value |
| | “OS 1” |
| | Corresponding OS Domain Object Instance |
| | “OS 2” |
| | Corresponding OS Domain Object Instance |
| | “OS 3” |
| | Corresponding OS Domain Object Instance |
| Port | Key |
| | Value |
| | “Port A1” |
| | Corresponding Port Domain Object Instance |
| | “Port B1” |
| | Corresponding Port Domain Object Instance |
| | “Port B2” |
| | Corresponding Port Domain Object Instance |
| | “Port C1” |
| | Corresponding Port Domain Object Instance |
| StorageVolume | Key |
| | Value |
| | “SV A1” |
| | Corresponding StorageVolume Domain |
| | Object Instance |
| | “SV B1” |
| | Corresponding StorageVolume Domain |
| | Object Instance |
| | “SV B2” |
| | Corresponding StorageVolume Domain |
| | Object Instance |
| | “SV C1” |
| | Corresponding StorageVolume Domain |
| | Object Instance |
| SystemSoftware | Key |
| | Value |
| | “SS 1” |
| | Corresponding SystemSoftware Association |
| | Object Instance |
| | “SS 2” |
| | Corresponding SystemSoftware Association |
| | Object Instance |
| | “SS 3” |
| | Corresponding SystemSoftware Association |
| | Object Instance |
| SystemDevice | Key |
| | Value |
| | “SD 1” |
| | Corresponding SystemDevice Association |
| | Object Instance |
| | “SD 21” |
| | Corresponding SystemDevice Association |
| | Object Instance |
| | “SD 22” |
| | Corresponding SystemDevice Association |
| | Object Instance |
| | “SD 3” |
| | Corresponding SystemDevice Association |
| | Object Instance |
| SCSIInterface | Key |
| | Value |
| | “SI 1” |
| | Corresponding SCSIInterface Association |
| | Object Instance |
| | “SI 21” |
| | Corresponding SCSllnterface Association |
| | Object Instance |
| | “SI 22” |
| | Corresponding SCSllnterface Association |
| | Object Instance |
| | “SI 3” |
| | Corresponding SCSIInterface Association |
| | Object Instance |

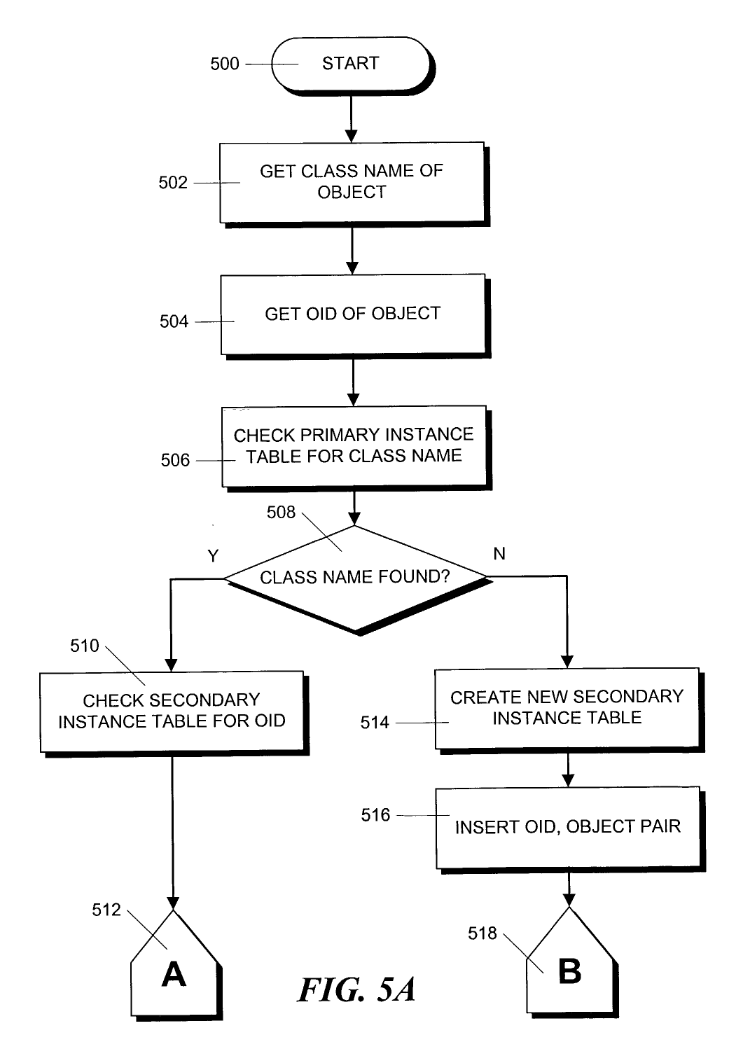

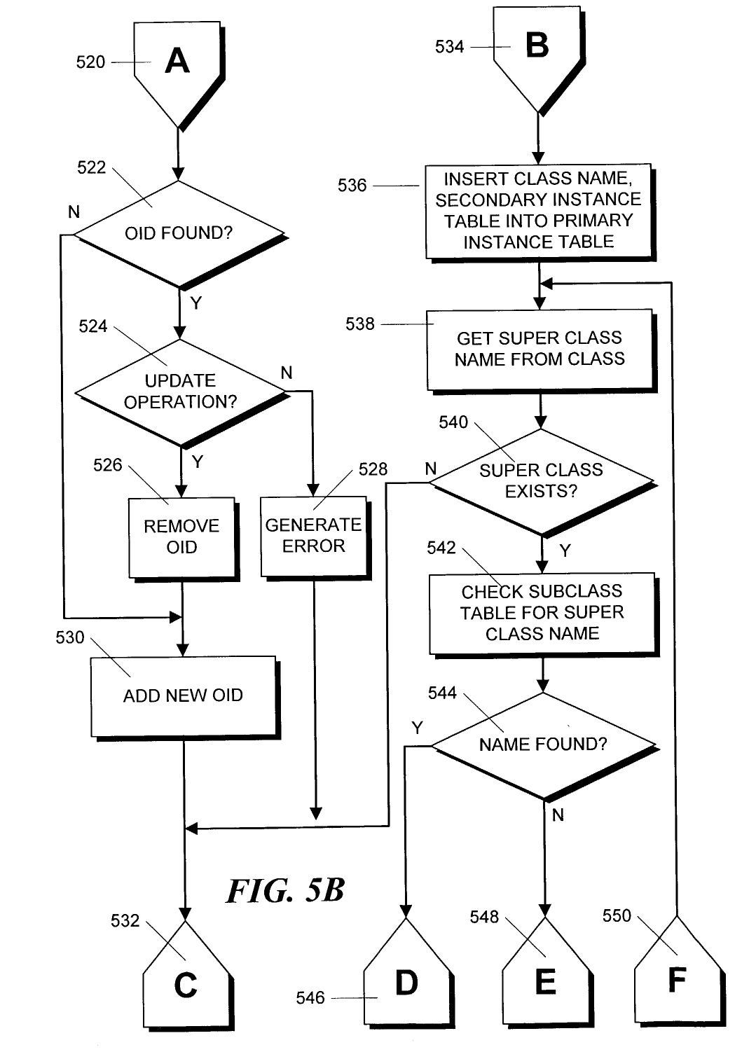

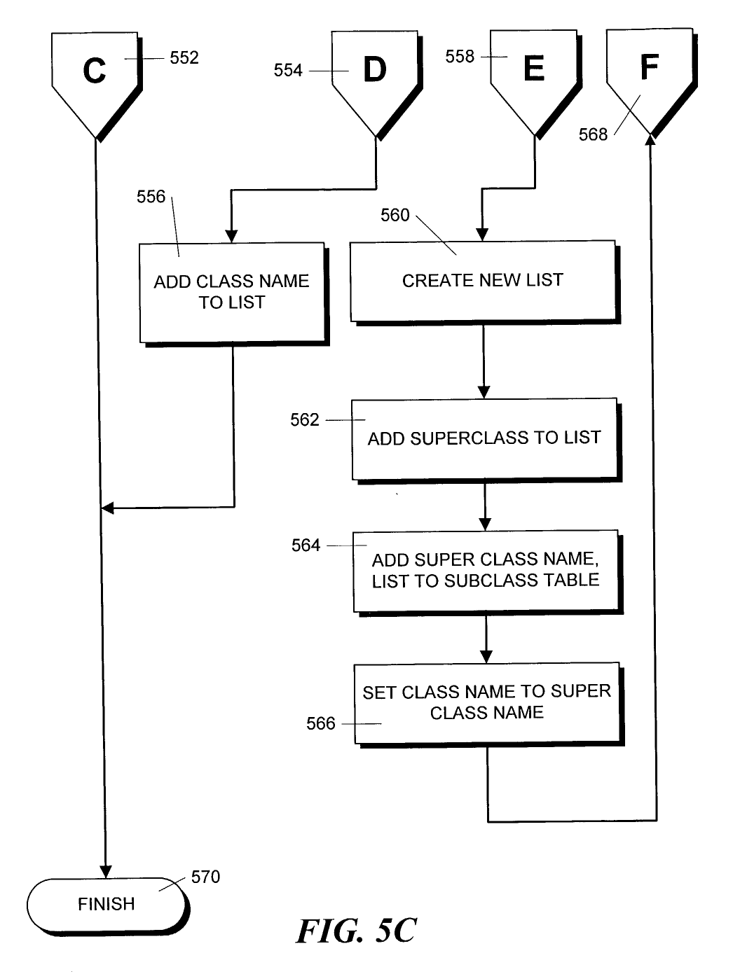

FIGS. 5A, 5B and 5C, when placed together, form a flowchart that illustrates how the subclass and the instance tables are built at runtime as each object instance is added. This process starts in step 500 and proceeds to step 502 where the object manager obtains the class of the object by invoking a “get” method on the object that returns the class name of the class used to instantiate the instance.

In step 504, the object manager obtains the OID of the object, again by invoking a get method of the object. Then, in step 506, the object manager checks the primary instance table, using the class name as the key. If, in step 508, the class name is found, then the routine that examines the primary instance table returns a reference to the secondary instance table that is the corresponding value. The process proceeds to step 510 where, using the returned reference, the secondary instance table is examined to determine whether the object OID already exists as a key in the table. The process then proceeds, via off-page connectors 512 and 520, to step 522.

If the OID does exist, as determined in step 522, then the object manager checks, in step 524, to determine whether an update operation is in process. If the operation is not an update process and the OID already exists, then an error is generated in step 528 and the process proceeds, via off-page connectors 532 and 552, to finish in step 568.

Alternatively, if in step 524, the object manager determines that an update operation is in process, then in step 526, the duplicate OID is removed. Next, in step 530, the new OID is added and the process proceeds, via off-page connectors 532 and 552, to finish in step 568.

If, in step 522, the OID is not found when the secondary instance table is checked, then the process proceeds directly to step 530 where the new OID is added and the process proceeds, via off-page connectors 532 and 552, to finish in step 568.

Returning to step 508, if the class name is not found in the primary instance table, then, in step 514, a new secondary instance table is created. In step 516, the new OID, object key-value pair is added. Then the process proceeds, via off-page connectors 518 and 534, to step 536 where the class name and the new secondary instance table are inserted into the primary instance table as a new key-value pair. Then, in step 538, a parent, or super class, of the class being processed is obtained by invoking a get method on the current class. If no super class exists, as determined in step 544, then the process proceeds, via off-page connectors 532 and 552 to finish in step 568.

Alternatively, if a super class is found in step 544, the process proceeds to step 542 where the subclass table is accessed using the super class name as a key. If the super class name exists in the subclass table, as determined in step 544, then the process proceeds, via off-page connectors 546 and 554 to step 556, where the class name is added to the list that forms the value of the key-value pair that has the super class name as the key.

However, if in step 544, the super class name is not a key in the subclass table, the process proceeds, via off-page connectors 548 and 558, to step 560 in which a new list is created and, in step 562, the class name is added to the list. Then, in step 564, the super class name and list are added to the subclass table as a new key-value pair.

This process is repeated to discover new super classes. In particular, in step 566, the class name is set to the newly discovered super class name and the process proceeds, via off-page connectors 568 and 550, back to step 538 where a new super class name is obtained from the former super class by invoking a get method on the class. Steps 540-566 are then repeated until in step 540 no new super class exists. The process then proceeds, via off-page connectors 532 and 552 to finish in step 568.

The inventive arrangement can efficiently answer queries because the number of CIM classes in a typical model is orders of magnitude less that the total number of managed CIM class instances. Therefore, the number of keys in the inventive primary instance table is much smaller than the number of keys in a conventional hash table that uses the OID as the key for each instance. During a query, once a client provides the OID of a CIM class instance along with the class name, the object manager can retrieve the secondary instance hash table corresponding to the CIM class name provided. Then the provided OID is used to retrieve the requested instance from the secondary instance hash table.

The average successful search time for the inventive arrangement will take O(1+a/m)+O(1+b/m), where m is the number of rows in the primary instance hash table, a is the number of classes in the CIM model, b is the average number of instances per CIM class in the model and a*b=n (the total number of instances in the system). If the total number of instances is very large, the search time is roughly linear to the number of instances per CIM class. If uniform distribution of the instances per CIM class is assumed, then the proposed method is order of 10 times faster even in the case of a very simple CIM model with ten classes. In real systems, the number of CIM classes often reaches the order of hundreds of classes, so the proposed scheme is 100 times faster than the standard solution.

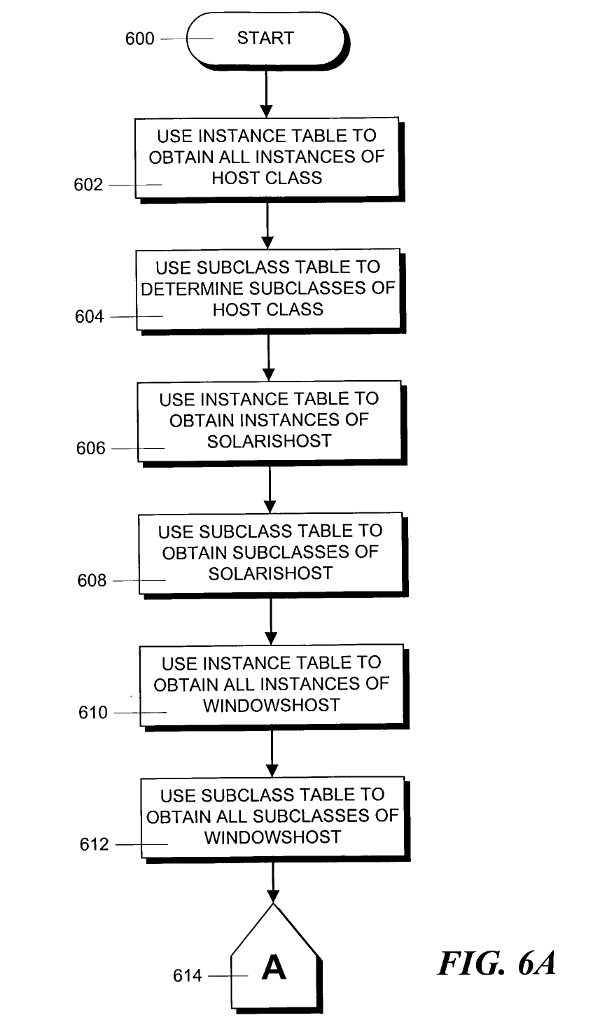

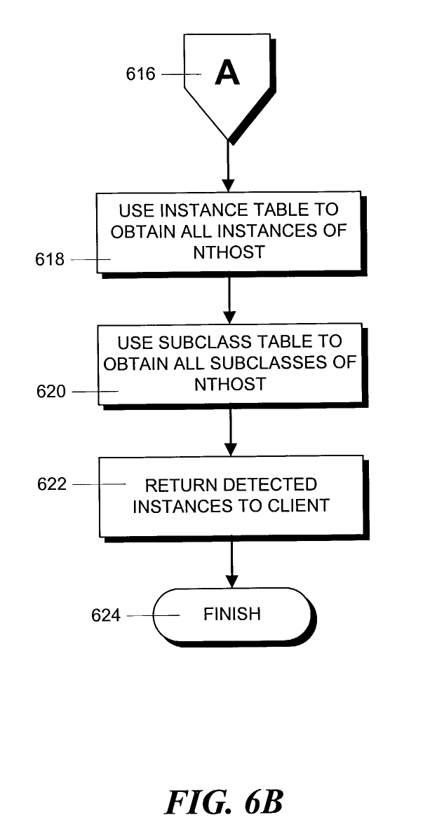

FIGS. 6A, 6B, 7, 8A, 8B and 9A-9C illustrate some examples of how different queries are handled by the object manager using the inventive arrangement. FIGS. 6A and 6B, when placed together, form a flowchart that illustrates the steps performed by the object manager in responding to a “getAllHosts” query on the system illustrated in FIGS. 3A-3C and using a subclass table such as Table 3 and an instance table such as Table 4.

The illustrated process starts in step 600 and proceeds to step 602 where the object manager looks at the primary instance table and collects all the instances of the Host class. At this point, the “Host C” instance is added to a list of instances to be returned by the query.

Next, in step 604, the object manager looks at the subclass table using the class name “Host” as a key and determines that all the instances of the SolarisHost subclass and the WindowsHost subclass must also be added to the list of instances to be returned by the query. In step 606, the object manager examines the instance table to collect all the instances of the SolarisHost class (in this process, the “Host A” instance is added to the list of instances returned by the query).

Next, the object manager examines the subclass table and determines in step 608 that no subclass instances exist for the CIM class SolarisHost. Accordingly, in step 610, the object manager examines the instance table to collect all instances of the WindowsHost class (since there are no such instances, nothing is added to the return list). Then, in step 612, the object manager examines the subclass table using the WindowsHost class a key to locate the NTHost subclass. The process then proceeds, via off-page connectors 614 and 616, to step 618 where the object manager examines the instance table to collect all the instances of the NTHost class (at which point the “Host B” instance is added to the return list).

The object manager then examines the subclass table, in step 620, and determines that no subclasses exist for the CIM class NTHost. Therefore, in step 622, the object manager returns a list of instances with OIDs “Host A,” “Host B,” and “Host C” to the client. The process then finishes in step 624.

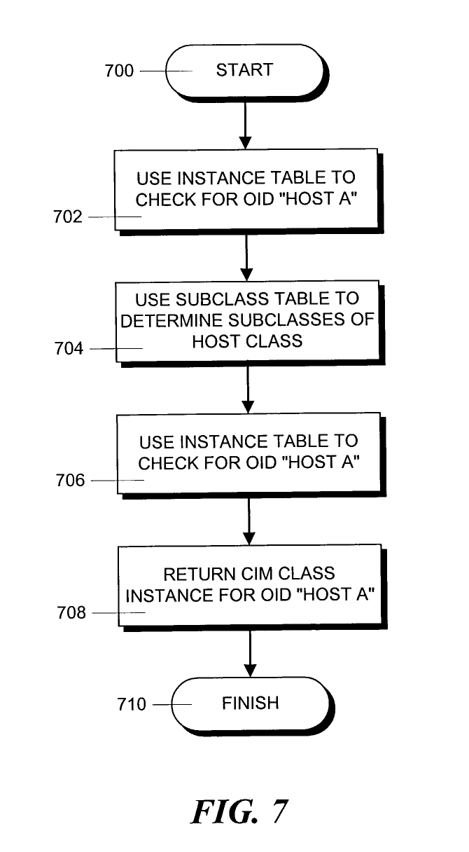

FIG. 7 is a flowchart that illustrates the steps performed by the object manager in responding to a “get a Host instance with the OID Host A” query on the system. The process begins in step 700 and proceeds to step 702 where the object manager examines the primary instance table using the class name Host and retrieves the secondary hash table of the CIM class Host. The object manager then determines that this secondary hash table does not contain the OID key “Host A” by using the key to perform a lookup on the table. However, the failure of this table to contain the key does not constitute a search failure because the requested OID could still be located in a subclass of the Host class.

Accordingly, in step 704, the object manager examines the subclass table to determine that the secondary instance tables corresponding to the SolarisHost and WindowsHost subclasses in the primary instance table must be searched. In step 706, the object manager retrieves the secondary instance table corresponding to the SolarisHost class from the primary instance table and checks for the OID “Host A.” Since this table contains the OID “Host A”, the object manager can retrieve and return the CIM class instance with OID “Host A” to the client in step 708 and the process ends in step 710.

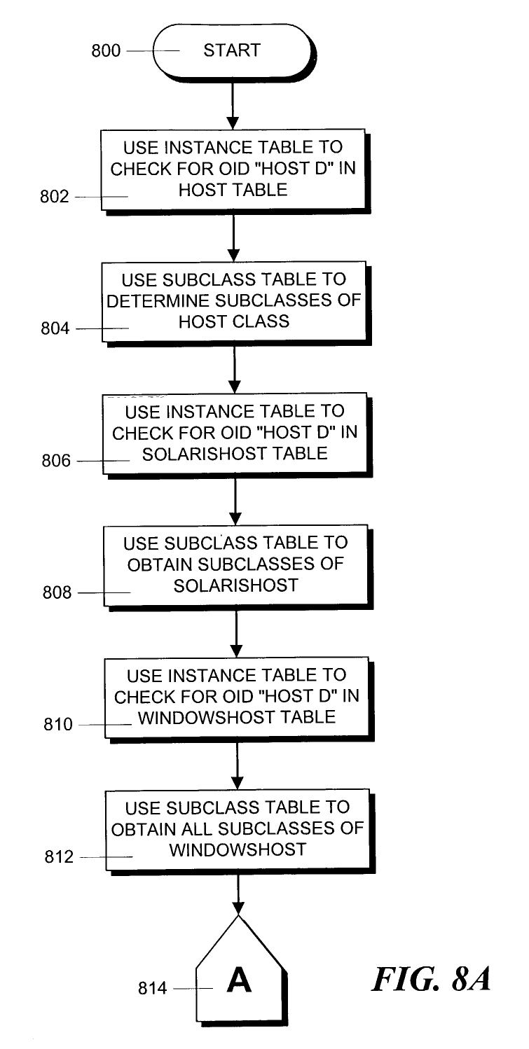

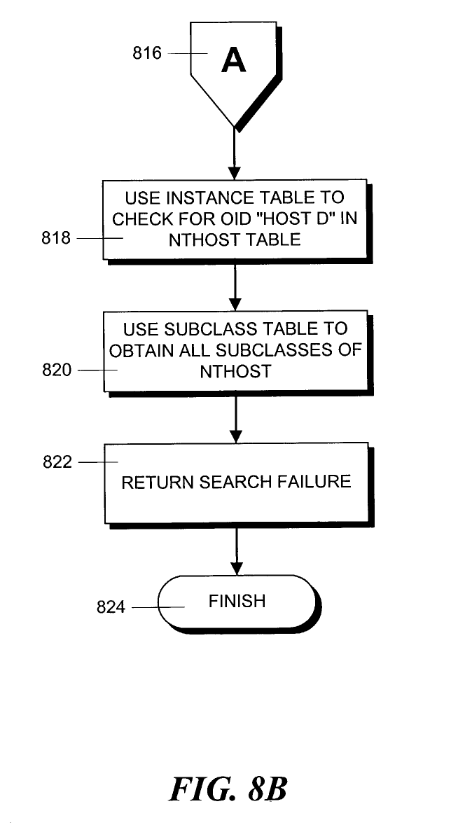

FIGS. 8A and 8B, when placed together, form a flowchart that illustrates the steps performed by an object manager in responding to a “get Host with OID Host D” query in the system. The process begins in step 800 and proceeds to step 802 where the object manager examines the primary instance table using the key Host to retrieve the secondary instance table of CIM class Host. The object manager examines this secondary instance table and determines that this secondary hash table does not contain the OID key “Host D”.

Then, in step 804, the object manager examines the subclass table and determines that the SolarisHost and WindowsHost classes are subclasses of the Host class so that the corresponding secondary instance tables must also be examined. In step 806, the secondary instance table for the class SolarisHost is retrieved and examined for the OID “Host D.” The object manager determines that the table does not contain the OID key provided. In step 808, the object manager uses the subclass table to determine that there are no subclass instances of the CIM class SolarisHost.

Then, in step 810, the object manager retrieves the secondary instance table using the class name WindowsHost as a key. The object manager examines the secondary instance table and determines that it does not contain the OID key provided. In step 812, the object manager uses the subclass table to determine that the class NTHost is a subclass of WindowsHost and that the secondary instance table corresponding to the NTHost class in the primary instance table must be searched. The process proceeds, via off-page connectors 814 and 816 to step 818 where the object manager retrieves the secondary instance table corresponding to the NTHost class from the primary instance table, and determines that it does not contain the key provided.

Finally, the object manager examines the subclass table and determines that there are no subclass instances of the CIM class NTHost and, accordingly, there are no further classes to search. At this point, the object manager knows there is no subclass of Host that could contain the requested OID, and, in step 822, it correctly reports a search failure. The process then ends in step 824.

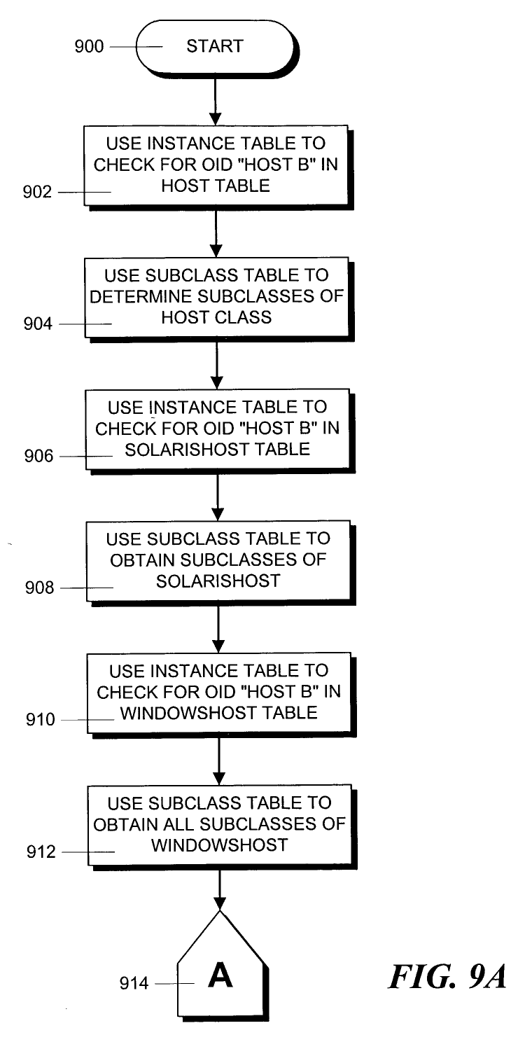

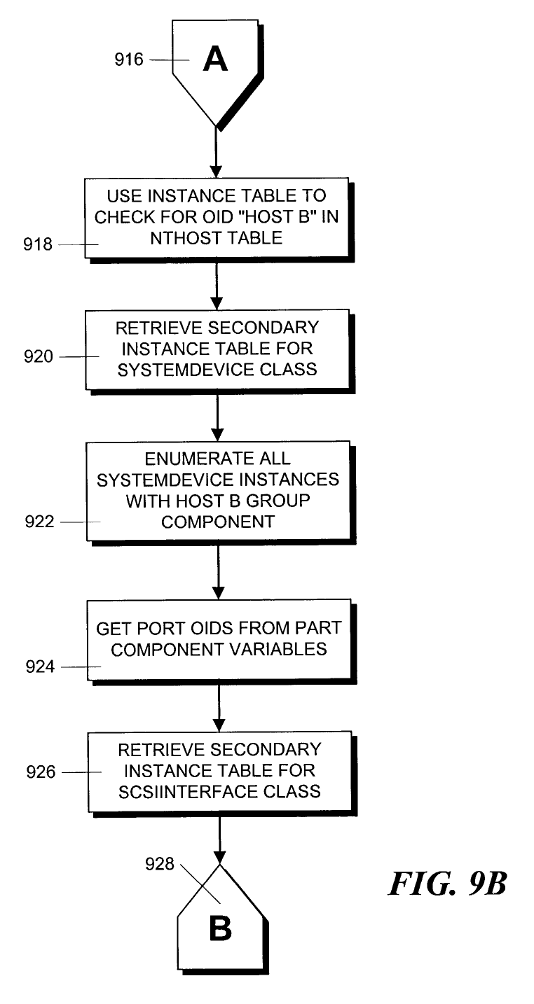

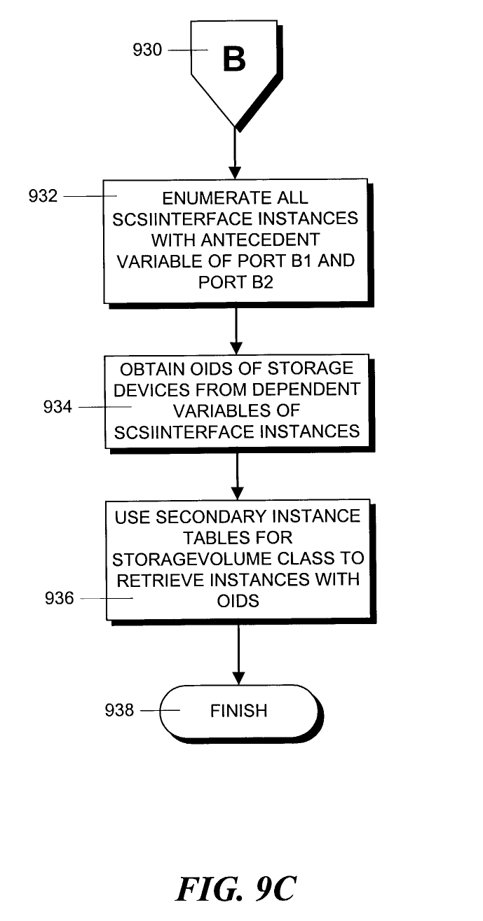

FIGS. 9A-9C, when placed together, form a flowchart illustrating the steps performed by the object manager in responding to a “get all the Storage Volumes of Host with OID Host B” query in the system. This process begins in step 900 and proceeds to step 902 where the object manager examines the primary instance table using the key Host to retrieve the secondary instance table of CIM class Host. The object manager examines this secondary instance table and determines that this secondary hash table does not contain the OID key “Host B”.

Then, in step 904, the object manager examines the subclass table and determines that the SolarisHost and WindowsHost classes are subclasses of the Host class so that the corresponding secondary instance tables must also be examined. In step 906, the secondary instance table for the class SolarisHost is retrieved and examined for the OID “Host B.” The object manager determines that the table does not contain the OID key provided. In step 908, the object manager uses the subclass table to determine that there are no subclass instances of the CIM class SolarisHost.

Then, in step 910, the object manager retrieves a secondary instance table using the class name WindowsHost as a key. The object manager examines the secondary instance table and determines that it does not contain the OID key provided. In step 912, the object manager uses the subclass table to determine that the class NTHost is a subclass of WindowsHost and that the secondary instance table corresponding to the NTHost class in the primary instance table must be searched. The process proceeds, via off-page connectors 914 and 916 to step 918 where the object manager retrieves the secondary instance table corresponding to the NTHost class from the primary instance table, and determines that it does contain the OID key Host B.

Then, in step 920, the object manager retrieves the secondary instance table for the CIM class SystemDevice from the primary instance table, using the class SystemDevice as a key. The object manager does this because it knows that the storage volume instances that are being sought are connected to the host class by the system device class. The object manager then enumerates all the SystemDevice instances that have a groupComponent variable referring to “Host B” in step 922. As set forth in FIG. 3B, this list comprises the instances “SD 21” and “SD 22”.

In step 924, the object manager gets the OID of the “Port B1” instance from the partComponent variable of the “SD 21” instance, and the OID of “Port B2” instance from the partComponent variable of the “SD 22” instance. The object manager then retrieves the secondary instance table for the CIM class SCSIInterface from the primary instance table in step 926. The process then proceeds, via off-page connectors 928 and 930 to step 932 where the object manager enumerates all the SCSIInterface instances that have an antecedent variable referring to “Port B1” or “Port B2”. As shown in FIG. 3B, this list includes the “SI 21” and “SI 22” SCSIInterface instances.

Then, in step 934, the object manager obtains the OID of the “SV B1” instance from the dependent variable of the “SI 21” SCSIInterface instance and the OID of the “SV B2” instance from the dependent variable of the “SI 22” SCSIInterface instance. The object manager retrieves the secondary hash tables for the CIM class StorageVolume in step 936 and retrieves the instances with OIDs “SV B1” and “SV B2”. These instances are returned in step 938 and the process finishes in step 940.

A software implementation of the above-described embodiment may comprise a series of computer instructions either fixed on a tangible medium, such as a computer readable media, for example, a diskette, a CD-ROM, a ROM memory, or a fixed disk, or transmittable to a computer system, via a modem or other interface device over a medium. The medium either can be a tangible medium, including but not limited to optical or analog communications lines, or may be implemented with wireless techniques, including but not limited to microwave, infrared or other transmission techniques. It may also be the Internet. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, pre-loaded with a computer system, e.g., on system ROM or fixed disk, or distributed from a server or electronic bulletin board over a network, e.g., the Internet or World Wide Web.

Although an exemplary embodiment of the invention has been disclosed, it will be apparent to those skilled in the art that various changes and modifications can be made which will achieve some of the advantages of the invention without departing from the spirit and scope of the invention. For example, it will be obvious to those reasonably skilled in the art that, in other implementations, queries and searches different from those shown may be performed. Other aspects, such as the specific process flow and the order of the illustrated steps, as well as other modifications to the inventive concept are intended to be covered by the appended claims.

What is claimed is:

1. A method for managing objects instantiated from CIM classes in a CIM environment, comprising:
(a) creating a subclass table containing entries that identify subclasses of each CIM class;
(b) creating an instance table containing entries that identify object instances for each class in the CIM environment;
(c) examining the subclass table to determine which classes to examine for instances; and
(d) examining the instance table to retrieve instances of a particular class.

2. The method of claim 1 wherein each entry in the subclass table contains a key-value pair in which the key is CIM class name and the value is a list of subclasses of the CIM class name.

3. The method of claim 1 wherein each entry in the instance table is a key-value pair in which the key is a CIM class name and the value is a secondary table containing entries that associate each object instance with an identifier for that instance.

4. The method of claim 1 wherein steps (a) and (b) are performed at runtime as each object instance is added to the CIM environment.

5. The method of claim 1 wherein step (a) comprises creating the subclass table as a hash table.

6. The method of claim 1 wherein step (b) comprises creating the instance table as a hash table.

7. The method of claim 1 wherein step (c) comprises using a CIM class name as a key to retrieve a list of subclass names from the subclass table.

8. The method of claim 7 wherein step (d) comprises using a CIM class name as a key to retrieve a table of object instances from the instance table.

9. The method of claim 8 wherein step (d) further comprises using an object identifier to access the table of object instances to retrieve a reference to a selected object instance.

10. The method of claim 9 wherein the object identifier is an OID.

11. The method of claim 8 wherein the table of object instances is a hash table.

12. The method of claim 11 wherein the table of object instances contains a plurality of entries, each entry being a key-value pair in which the key is an OID and the value is a reference to an object instance.

13. Apparatus for managing objects instantiated from CIM classes in a CIM environment, comprising:
a subclass table containing entries that identify subclasses of each CIM class;
an instance table containing entries that identify object instances for each class in the CIM environment;
a mechanism that examines the subclass table to determine which classes to examine for instances; and
a mechanism that examines the instance table to retrieve instances of a particular class.

14. The apparatus of claim 13 wherein each entry in the subclass table contains a key-value pair in which the key is CIM class name and the value is a list of subclasses of the CIM class name.

15. The apparatus of claim 13 wherein each entry in the instance table is a key-value pair in which the key is a CIM class name and the value is a secondary table containing entries that associate each object instance with an identifier for that instance.

16. The apparatus of claim 13 further comprising a mechanism for building the subclass table and the instance table at runtime as each object instance is added to the CIM environment.

17. The apparatus of claim 13 wherein the subclass table is a hash table.

18. The apparatus of claim 13 wherein the instance table is a hash table.

19. The apparatus of claim 13 wherein the mechanism that examines the subclass table comprises a mechanism that uses a CIM class name as a key to retrieve a list of subclass names from the subclass table.

20. The apparatus of claim 19 wherein the mechanism that examines the instance table comprises a mechanism that uses a CIM class name as a key to retrieve a table of object instances from the instance table.

21. The apparatus of claim 20 the mechanism that examines the instance table further comprises a mechanism that uses an object identifier to access the table of object instances to retrieve a reference to a selected object instance.

22. The apparatus of claim 21 wherein the object identifier is an OID.

23. The apparatus of claim 20 wherein the table of object instances is a hash table.

24. The apparatus of claim 23 wherein the table of object instances contains a plurality of entries, each entry being a key-value pair in which the key is an OID and the value is a reference to an object instance.

25. Apparatus for managing objects instantiated from CIM classes in a CIM environment, comprising:
means for creating a subclass table containing entries that identify subclasses of each CIM class;
means for creating an instance table containing entries that identify object instances for each class in the CIM environment;
means for examining the subclass table to determine which classes to examine for instances; and
means for examining the instance table to retrieve instances of a particular class.

26. The apparatus of claim 25 wherein each entry in the subclass table contains a key-value pair in which the key is CIM class name and the value is a list of subclasses of the CIM class name.

27. The apparatus of claim 25 wherein each entry in the instance table is a key-value pair in which the key is a CIM class name and the value is a secondary table containing entries that associate each object instance with an identifier for that instance.

28. The apparatus of claim 25 further comprising means for building the subclass table and the instance table at runtime as each object instance is added to the CIM environment.

29. A computer program product for managing objects instantiated from CIM classes in a CIM environment, the computer program product comprising a computer usable medium having computer readable program code thereon, including:
program code for creating a subclass table containing entries that identify subclasses of each CIM class;
program code for creating an instance table containing entries that identify object instances for each class in the CIM environment;
program code for examining the subclass table to determine which classes to examine for instances; and
program code for examining the instance table to retrieve instances of a particular class.

30. The computer program product of claim 29 wherein each entry in the subclass table contains a key-value pair in which the key is CIM class name and the value is a list of subclasses of the CIM class name.

31. The computer program product of claim 29 wherein each entry in the instance table is a key-value pair in which the key is a CIM class name and the value is a secondary table containing entries that associate each object instance with an identifier for that instance.

32. The computer program product of claim 29 further comprising program code for building the subclass table and the instance table at runtime as each object instance is added to the CIM environment.

33. A computer data signal embodied in a carrier wave for managing objects instantiated from CIM classes in a CIM environment, the computer data signal comprising:
program code for creating a subclass table containing entries that identify subclasses of each CIM class;
program code for creating an instance table containing entries that identify object instances for each class in the CIM environment;
program code for examining the subclass table to determine which classes to examine for instances; and
program code for examining the instance table to retrieve instances of a particular class.
